(19) United States
(12) Patent Application Publication
(10) Pub. No.: US 2019/0392816 A1
(43) Pub. Date: Dec. 26, 2019

(54) SPEECH PROCESSING DEVICE AND SPEECH PROCESSING METHOD

(71) Applicant: LG ELECTRONICS INC., Seoul (KR)

(72) Inventors: Yekyung KIM, Seoul (KR); Gyeonghun KIM, Seoul (KR); Yejin KIM, Seoul (KR)

(73) Assignee: LG ELECTRONICS INC., Seoul (KR)

(21) Appl. No.: 16/561,777

(22) Filed: Sep. 5, 2019

(30) Foreign Application Priority Data
Aug. 12, 2019 (KR) 10-2019-0098437

(51) Int. Cl. G10L 15/06; G10L 15/22; G10L 15/16

(52) U.S. Cl. CPC G10L 15/063; G10L 2015/223; G10L 15/16; G10L 15/22

(57) ABSTRACT

A speech processing method includes learning to obtain at least one region-specific weight information for each word included in an utterance of a speaker, and updating word embedding information based on the at least one region-specific weight information obtained for each of the word.

### CROSS-REFERENCE TO RELATED APPLICATIONS

The present application claims priority under 35 U.S.C. 119 and 35 U.S.C. 365 to Korean Patent Application No. 10-2019-0098437 (filed on Aug. 12, 2019), which is hereby incorporated by reference in its entirety.

### BACKGROUND

The present disclosure relates to a speech processing device and a speech processing method, and more particularly, to a speech processing device and a speech processing method capable of obtaining word embedding information optimized for dialect based on artificial intelligence.

Recently, technology for recognizing and processing speech has been explodingly developed by combining artificial intelligence, IoT, robots, and autonomous vehicles.

Current speech recognition is developed based on standard language. However, although many speakers use dialect, speech recognition technology has not been developed yet. Accordingly, a robot having such a speech recognition function does not recognize the dialect of the speaker, and thus a wrong answer is provided or an answer cannot be made. Therefore, accurate speech recognition for dialect as well as standard language has become a very important factor in the application of various applications and thus, the development of this is urgently needed.

### SUMMARY

The embodiment aims to solve the above and other problems.

Another object of the embodiment is to provide a speech processing device and a speech processing method that can accurately recognize dialect as well as standard language and can be applied to various applications.

In one embodiment, a speech processing method includes: learning to obtain at least one region-specific weight information for each word included in an utterance of a speaker; and updating word embedding information based on the at least one region-specific weight information obtained for each of the word.

In another embodiment, a speech recognition device includes: a memory configured to store word embedding information; and a processor. The processor learns to obtain at least one region-specific weight information for each word included in an utterance of a speaker, and updates the word embedding information based on the at least one region-specific weight information obtained for each of the word.

The additional scope of applicability of the embodiment will become apparent from the following detailed description. However, since various changes and modifications within the spirit and scope of the embodiment may be understood by those skilled in the art, it should be understood that the specific embodiments, such as the detailed description and the preferred embodiments, are given as examples only.

### BRIEF DESCRIPTION OF THE DRAWINGS

FIG. 1 illustrates an AI device 100 according to an embodiment of the present invention.

FIG. 2 illustrates an AI server 200 according to an embodiment of the present invention.

FIG. 3 illustrates an AI system 1 according to an embodiment of the present invention.

FIG. 4 illustrates a speech processing device according to an embodiment of the present invention.

FIG, 4 is a flowchart illustrating a speech processing method according to an embodiment of the present invention.

FIG. 6 is a diagram for explaining a first learning model.

FIG. 7 shows word embedding information obtained by a first learning model.

FIG. 8 is a diagram for explaining a second learning model.

FIG. 9 shows weight information obtained by a second learning model.

FIG. 10 shows updated word embedding information.

FIG. 11 is an exemplary view showing a conversation with a robot.

### DETAILED DESCRIPTION OF THE EMBODIMENTS

### Artificial Intelligence (AI)

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

### Robot

A robot may refer to a machine that automatically processes or operates a given task by it own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

### Self-Driving

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

### eXtended Reality (XR)

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

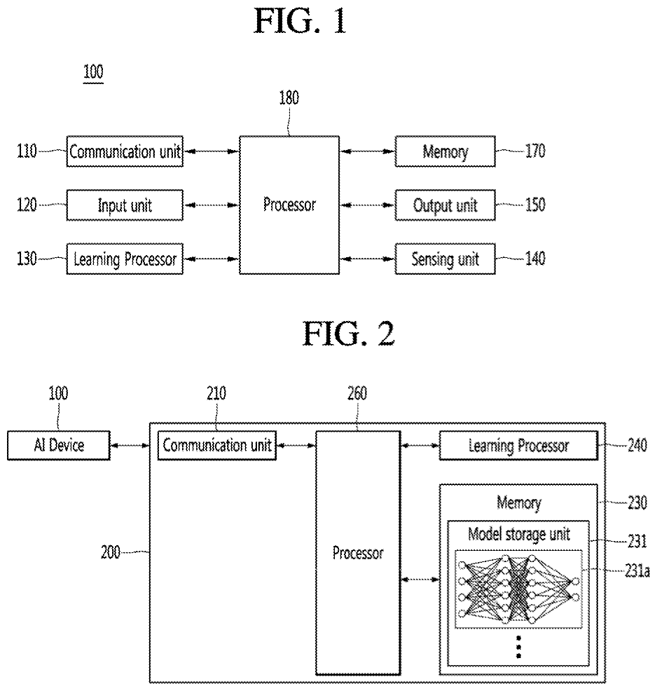

FIG. 1 illustrates an AI device 100 according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning Processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

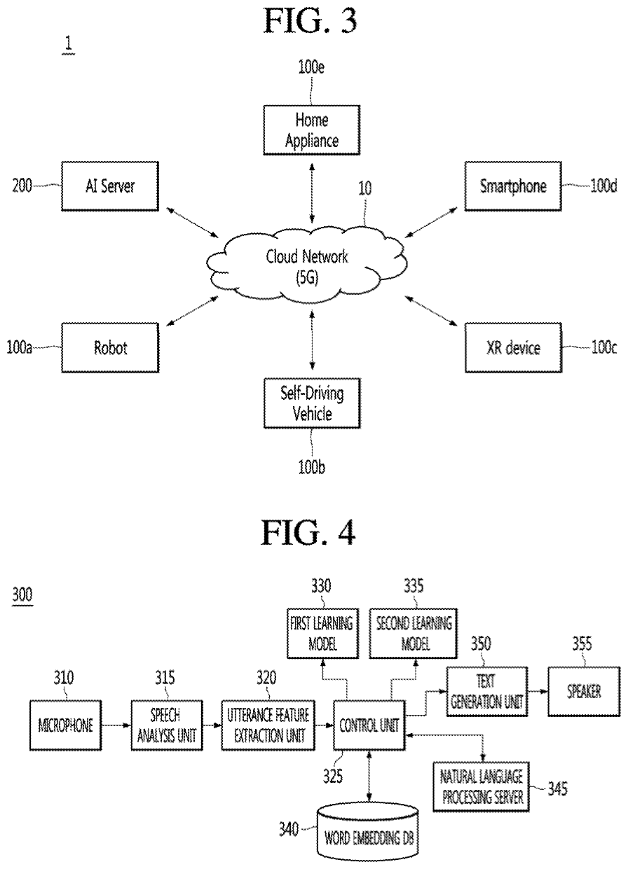

FIG. 3 illustrates an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

### AI+Robot

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

### AI+Self-Driving

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware.

The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

### AI+XR

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

### AI+Robot+Self-Driving

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

### AI+Robot+XR

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

### AI+Self-Driving+XR

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction

The word embedding model described below can obtain a vector of each word by learning in a manner of mapping to points close to each other with respect to words that are similar to each other in terms of semantics. This word embedding model can be implemented using, for example, word2vec, glove, and fastText. Since the conventional method of implementing the word embedding model has been known, the parts omitted in the following description may be understood from the known method of implementing the word embedding model.

Generally, word embedding model is trained based on standard language. In the present invention, not only the standard language but also the non-standard language may be extended to correspond to the dialect of the speaker. To this end, in the present invention, the word embedding information may be updated to include vector values for each dialect for each word by learning about a non-standard language as well as a standard language. This will be described in more detail below.

FIG. 4 illustrates a speech processing device according to an embodiment of the present invention.

Referring to FIG. 4, the speech processing device 300 according to an embodiment of the present invention may includes a microphone 310, a speech analysis unit 315, an utterance feature extraction unit 320, a control unit 325, a first learning model 330, a second learning model 335, and a word embedding database 340.

The speech processing device 300 according to an embodiment of the present invention may include a natural language processing server 345. The speech processing device 300 according to an embodiment of the present invention may include a text generation unit 350 and a speaker 355.

Although not shown in the drawings, the speech processing device 300 according to an embodiment of the present invention may include a matching agent to map a sentence corresponding to the utterance of the speaker. The utterance of the speaker may include, for example, a single word, phrase, sentence, or the like. The utterance of the speaker may include, for example, a spoken language, an honorific language, a conversational language, a talk-down language, an interrogative sentence, and the like.

The speech processing device 300 according to an embodiment of the present invention may include more or less components than those described above.

The microphone 310 may be included in the input unit 120 shown in FIG. 1. The first learning model 330, the second learning model 335, and the word embedding database 340 may be included in the memory 170 shown in FIG. 1, but are not limited thereto. The speech analysis unit 315, the utterance feature extraction unit 320, the control unit 325, and the text generation unit 350 may be included in the processor 180 shown in FIG. 1. The speaker 355 may be included in the output unit illustrated in FIG. 1. For example, the natural language processing server 345 may be included in the AI server 200 shown in FIG. 2. As another example, the natural language processing function performed by the natural language processing server 345 may be a natural language processing engine and may be stored in the memory 170 shown in FIG. 1.

The microphone 310 may acquire the speech of the speaker. The microphone 310 may convert the speech signal of the speaker into electrical speech data. Various noise canceling algorithms for removing noise occurring during the reception of external sound signals may be implemented in the microphone 310. As an example, a response corresponding to speech data of the speaker may be outputted as, for example, speech under the control of the control unit 325, but the present disclosure is not limited thereto.

Although not shown in the drawings, the speech processing device 300 according to an embodiment of the present invention may include an audio processing unit between the microphone 310 and the speech analysis unit 315. The audio processing unit may preprocess the speech of the speaker. The audio processor may include a speech to text conversion unit, a wave processing unit, a frequency processing unit, and a power spectrum processing unit. The STT conversion unit can convert speech data into text data. The wave processing unit may extract a speech waveform corresponding to speech data. The frequency processing unit may extract a frequency band of speech data. The power spectrum processing unit may extract a power spectrum of speech data.

The speech analysis unit 315 may analyze the features of the converted text. The feature of the text may include one or more of a word or a topic. The speech analysis unit 315 may measure the speech utterance speed of the user. The speech analysis unit 315 may measure the strength of speech. The speech analysis unit 315 may measure the pitch of speech. The pitch of speech may represent the height of speech. The speech analysis unit 315 may measure the power spectrum of speech. The speech analysis unit 315 may analyze the surrounding situation of the speaker based on the sensing data acquired by the sensing unit (not shown). The speech analysis unit 315 may analyze the context of the current situation of the speaker using the sensing data or the speech data.

The utterance feature extraction unit 320 may extract the utterance feature of the speaker based on the analysis result of the speech analysis unit 315. As an example, the utterance feature of the speaker may include one or more of word/topic, stem/ending, or utterance speed/style. As another example, the utterance feature of the speaker may include one or more of accent, accent, level of voice, intensity, or length. These accents, intonation, levels of voice, intensity, length, etc. can be used as important parameters to distinguish various dialects for the same word. That is, various region-specific dialects can be identified by the combination of these parameters.

The control unit 325 may manage or control the components included in the embodiment of the present invention as a whole. In particular, the control unit 325 may control to learn the first learning model 330 and/or the second learning model 335.

For example, the control unit 325 may train the first learning model 330 to obtain word embedding information corresponding to the word data.

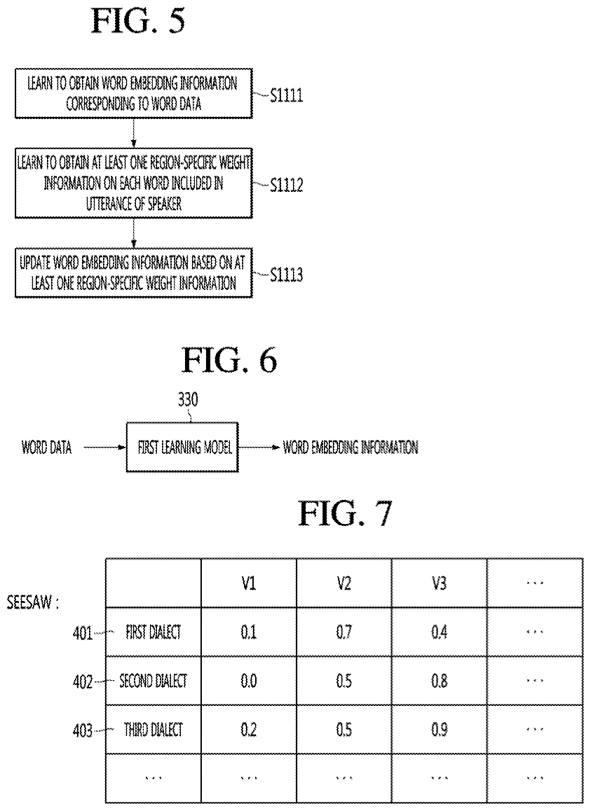

As shown in FIG. 6, when the word data is inputted, the first learning model 330 may acquire word embedding information corresponding to the word data. Word data may be collected in advance. Word data may include not only standard languages but also non-standard languages such as dialect. As word data, a standard language dictionary or a dialect dictionary can be used. Field visits can be conducted on each region-specific basis to collect word data. Word data may be generated based on text. For example, when text is inputted, word data corresponding to the text may be generated. The first learning model 330 may be implemented using, for example, word2vec, glove, and fastText.

The word embedding information outputted by the first learning model 330 may include a vector value indicating a similar relationship between at least one dialect and a plurality of dimensions for each word. One dialect of at least one dialect may be a standard language.

The plurality of dimensions may indicate a word having a similarity or a high degree to the corresponding word. As shown in FIG. 7, a plurality of dimensions of the word ‘SEESAW’ may be, for example, PLAY, GYM, CHILDREN, or the like. The number of dimensions may be determined or forcedly determined depending on how many words similar to the word exist.

When there are three dialects 401, 402, and 403 for ‘SEESAW’, the first dialect 401 may be a dialect of ‘SEESAW’ used in the first region, and the second dialect 402 may be a dialect of ‘SEESAW’ used in a second region different from the first region, and the third dialect 403 may be a ‘SEESAW’ dialect used in a third region different from the first region or the second region. For example, the first region may be “North Region”, the second region may be South Region, and the third region may be “Midland Region”.

Tt is assumed that V1 is ‘PLAY’, V2 is ‘GYM’, and V3 is ‘CHILDREN’. In this case, the similarity between the first dialect 401 and PLAY may have a vector value of 0.1, and the similarity between the first dialect 401 and GYM may have a vector value of 0.7, and the similarity between the first dialect 401 and the CHILDREN may have a vector value of 0.4. The similarity between the second dialect 402 and PLAY may have a vector value of 0.0, and the similarity between the second dialect 402 and GYM may have a vector value of 0.5, and the similarity between the second dialect 402 and the CHILDREN may have a vector value of 0.8. Here, the similarity between 2 dialect and PLAY has a vector value of 0.0, which may mean that there is no relation between the second dialect 402 and PLAY. For example, when the dimensions V1, V2, and V3 are ‘CLOTHES’, and the similarity between them has a vector value of 0, ‘CLOTHES’ and ‘SEESAW’ may mean that there is no relationship.

The similarity between the third dialect 403 and PLAY may have a vector value of 0.2, and the similarity between the third dialect 403 and GYM may have a vector value of 0.5, and the similarity between the third dialect 403 and the CHILDREN may have a vector value of 0.9.

As more various and extensive word data are inputted as the input of the first learning model 330, more accurate word embedding information may be obtained.

The control unit 325 may control to store the obtained word embedding information in the word embedding database 340.

Meanwhile, the control unit 325 may train the second learning model 335 to obtain at least one or more region-specific weight information for each word included in the utterance of the speaker.

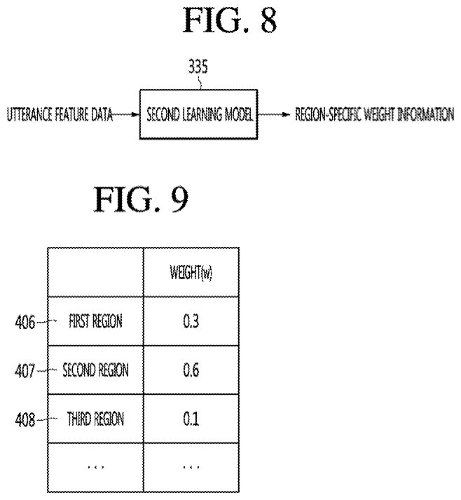

As shown in FIG. 8, when the utterance feature data is inputted, the second learning model 335 may acquire region-specific weight information corresponding to the utterance feature data. The utterance feature data may be obtained from the utterance feature extraction unit 320. The utterance feature data may include one or more of accent, accent, level of voice, intensity, or length. Various region-specific dialects can be identified by a combination of parameters such as accent, intonation, level of voice, intensity, length, and the like.

The second learning model 335 may obtain region-specific weight information by learning utterance feature data including one or more of accent, intonation, level of voice, intensity, or length. As shown in FIG. 9, the second learning model 335 may learn utterance feature data for a specific word included in the utterance of the speaker to obtain different region-specific weight information. The specific words included in the utterance of the speaker depend on the region where a user lives. For example, if one of the words in the speaker's utterance is ‘TEETER-TOTTER’, that is, the dialect of ‘SEESAW’, the corresponding ‘TEETER-TOTTER’ may be, for example, may represent, as a weight, a probability of being a dialect of each of the first region 406, the second region 407, and the third region 408. For example, the first region 406 may be “North Region”, the second region 407 may be “South Region”, and the third region 408 may be “Midland Region”.

In this case, as shown in FIG. 9, the probability that the word ‘TEETER-TOTTER’ included in the utterance of the speaker is included in the first region 406, that is, the weight may be 0.3 and, the weight to be included in the second region 407 may be 0.6, and the weight value to be included in the third region 408 may be 0.1. From this, it may be assumed that the word ‘TEETER-TOTTER’ is likely a dialect for the second region.

Similarly, other words included in the utterance of the speaker are also learned by the second learning model 335 so that region-specific weight information similar to that shown in FIG. 9 can be obtained. That is, region-specific weight information may be obtained for each word included in the utterance of the speaker.

The control unit 325 may control to update the word embedding information based on the acquired region-specific weight information. For example, the control unit 325 may find word embedding information corresponding to the same word as the word used for obtaining the acquired region-specific weight information from the word embedding database 340, and update the word embedding information based on the acquired region-specific weight information. In detail, the control unit 325 may update the word embedding information by calculating each of the acquired region-specific weight information and each vector value of the word embedding information. Specifically, a vector value of region-specific weights and word embedding information may be multiplied, but the present invention is not limited thereto.

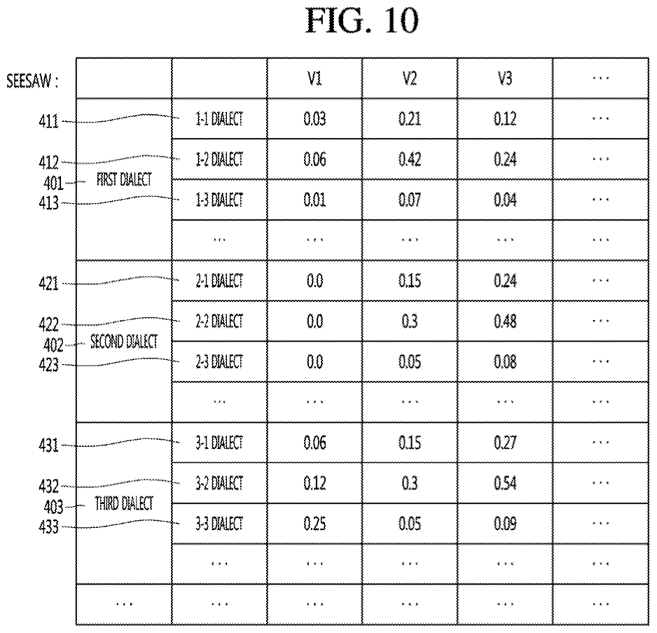

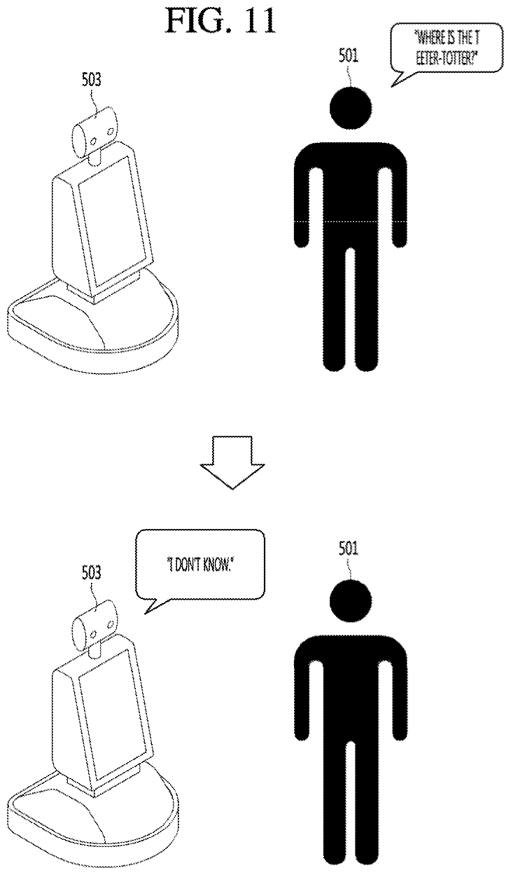

FIG. 10 illustrates new word embedding information generated by updating the word embedding information shown in FIG. 7 based on the weight information shown in FIG. 9.

Both the word embedding information shown in FIG. 7 and the weight information shown in FIG. 9 may be obtained for the word ‘SEESAW’. in this case, the weight 0.3 of the first region included in the weight information shown in FIG. 9 and each vector value (0.1, 0.7, 0.4) according to the first dialect 401 shown in FIG. 7 are multiplied so that it can be updated to a vector value (0.03, 0.21, 0.12) according to the 1-1 dialect 411. The weight 0.6 of the second region 407 included in the weight information shown in FIG. 9 and each vector value (0.1, 0.7, 0.4) according to the first dialect 401 shown in FIG. 7 are multiplied so that it can be updated to a vector value (0.06, 0.42, 0.24) according to the 1-2 dialect 412. The weight 0.1 of the third region 408 included in the weight information shown in FIG. 9 and each vector value (0.1, 0.7, 0.4) according to the first dialect 401 shown in FIG. 7 are multiplied so that it can be updated to a vector value (0.01, 0.07, 0.04) according to the 1-3 dialect 413.

In this way, the second dialect 402 is updated to a vector value according to each of the 2-1 dialect 421, the 2-2 dialect 422, and the 2-3 dialect 423, and the third dialect 403 may be updated to a vector value according to each of the 3-1 dialect 431, the 3-2 dialect 432, and the 3-3 dialect 433.

On the other hand, the control unit 325 may control to perform natural language processing on speech data for the utterance of the speaker. For example, the control unit 325 may transmit, to the natural language processing server 345, speech data on the utterance of the speaker together with the updated word embedding information. The control unit 325 may receive the natural language processed result from the natural language processing server 345. The control unit 325 may obtain the intention of the utterance of the speaker based on the natural language processed result. As another example, the natural language processing server 345 may be omitted, and the natural language processing function may be included in the control unit 325. In this case, the control unit 325 performs natural language processing on the speech data on the utterance of the speaker based on the updated word embedding information so that it may obtain the intention of the speaker's utterance.

The text generation unit 350 may generate text to be outputted to the speaker 355. The control unit 325 may generate text corresponding to the intention of the speaker. To this end, the speech processing device 300 according to an embodiment of the present invention may include a correspondence relational database (not shown). In the correspondence relational database, related words that may constitute a sentence, phrase, short sentence, or long sentence may be tabulated into a relation table according to the intention of the utterance of the speaker. For example, when the intention of the speaker is for a restaurant recommendation, a word related to the restaurant recommendation may be stored in a correspondence relational database as a relation table. Thus, if the intention of the speaker is for a restaurant recommendation, the control unit 325 obtains “this way,” “300m,” “go,” “food,” “town,” etc. from the correspondence relational database and provides this to the text generation unit 350, and the text generation unit 350 generates the text “Go 300m to this side, there is a food town,” using the acquired words. Then, the generated text may be outputted as speech through the speaker 355.

According to an embodiment of the invention, by updating word embedding information including vector values according to at least one dialect including a standard language based on at least one region-specific weight information obtained by learning the utterance of the speaker, the dialect included in the utterance of the speaker is reflected in the word embedding information to accurately recognize the utterance of the speaker. By accurately obtaining the intention of the speaker through the utterance of the speaker correctly recognized in such a way, actions corresponding to the intention thereof can be taken. For example, as shown in FIG. 11, even if the utterance of the speaker 501 includes a dialect “TEETER-TOTTER” the robot 503 can update the word embedding information in the manner described above to accurately recognize the dialect, that is, “TEETER-TOTTER” and accordingly, the intention of the speaker 501 can be accurately understood. That is, the robot 503 may determine that the speaker 501 queries a specific sports facility, and in response to the query, the robot 503 may output the specific sports facility desired by the speaker as speech. In this case, the speech outputted by the robot 503 may be standard language or dialect. The robot 503 may respond with a standard language or dialect in consideration of the situation at that time, for example, the mood of the speaker 501 or the place where the robot is located. Alternatively, the robot 503 may respond with a standard language or dialect as being set.

FIG. 5 is a flowchart illustrating a speech processing method according to an embodiment of the present invention.

Referring to FIGS. 1, 4, and 5, the control unit 325 may learn the first learning model 330 to obtain word embedding information corresponding to the word data (S1111).

For example, the control unit 325 may acquire whether to receive word data. The word data may be inputted through the input unit. Word data may include not only standard languages but also non-standard languages such as dialect. Word data may be collected in advance. Word data may be inputted at once or may be periodically inputted for learning of the first learning model 330.

When receiving word data, the control unit 325 may provide word data as an input of the first learning model 330 to control the first learning model 330 to learn word data and obtain word embedding information. As shown in FIG. 7, the obtained word embedding information may include a vector value indicating a similarity between at least one dialect and a plurality of dimensions for each word. The control unit 325 may store the obtained word embedding information in a memory. When the word data inputted later by the first learning model 330 is learned to acquire word embedding information, the acquired word embedding information may be stored in a memory.

The control unit 325 may learn to acquire at least one or more region-specific weight information for each word included in the utterance of the speaker (S1112).

After the utterance of the speaker is inputted through the microphone 310, the utterance feature data may be obtained through the speech analysis unit 315 and the utterance feature extraction unit 320. The utterance feature data, for example, may include one or more of accent, accent, level of voice, intensity, or length.

When receiving utterance feature data, the control unit 325 provides the utterance feature data as an input of the second learning model 335 and controls the second learning model 335 to learn utterance feature data and obtain region-specific weight information. As shown in FIG. 9, region-specific weight information may include a weight for at least one region for each word included in the utterance of the speaker. At least one or more regions are regions where the word is used, and the weight may indicate a probability that the word is used in the region.

The control unit 325 may update the word embedding information based on at least one region-specific weight information. As described above, word embedding information may be obtained by the first learning model 330, and region-specific weight information may be obtained by the second learning model 335. The control unit 325 may update the obtained word embedding information based on the obtained region-specific weight information in such a way. As shown in FIG. 10, the word embedding information may be updated by calculating a vector value of region-specific weights and word embedding information. In other words, the word embedding information may be updated by reflecting a weight to be used for each region in the vector value of at least one dialect for each word. Accordingly, the updated word embedding information may include distribution information on a region where the dialect of a word included in an utterance of a speaker is frequently used. Through this updated word embedding information, it is easy to identify which region's dialect the utterance of the speaker is, it is possible to deal with the identified result or respond to the speaker using the identified result.

The effects of the speech processing device and speech processing method according to the embodiment are described as follows.

According to at least one of embodiments, by updating word embedding information including vector values according to at least one dialect including a standard language based on at least one region-specific weight information obtained by learning the utterance of the speaker, the dialect included in the utterance of the speaker is reflected in the word embedding information to accurately recognize the utterance of the speaker. By accurately obtaining the intention of the speaker through the utterance of the speaker correctly recognized in such a way, actions corresponding to the intention thereof can be taken.

According to at least one of embodiments, the updated word embedding information may include distribution information on a region where the dialect of a word included in an utterance of a speaker is frequently used. Through this updated word embedding information, is easy to identify which region's dialect the utterance of the speaker is, it is possible to deal with the identified result or respond to the speaker using the identified result.

The foregoing detailed description is to be regarded as illustrative and not restrictive. The scope of the embodiment should be determined by reasonable interpretation of the appended claims, and all modifications within equivalent ranges of the embodiment are included in the scope of the embodiment.

What is claimed is:

1. A speech processing method comprising:
learning to obtain at least one region-specific weight information for each word included in an utterance of a speaker; and
updating word embedding information based on the at least one region-specific weight information obtained for each of the word.

2. The method of claim 1, further comprising, before the learning to obtain the weight information, learning to obtain the word embedding information corresponding to word data.

3. The method of claim 1, wherein the word embedding information is updated for a word used for obtaining the at least one region-specific weight information.

4. The method of claim 1, wherein the word data comprises at least one dialect for each word, and
the at least one dialect comprises a standard language.

5. The method of claim 1, wherein the word embedding information comprises a vector value indicating a similar relationship between at least one dialect and a plurality of dimensions.

6. The method of claim 5, wherein the updating of the word embedding information comprises calculating each of the at least one region-specific weight and each of the vector values.

7. The method of claim 1, wherein the learning to obtain the weight information comprises:
obtaining at least one utterance feature data comprising at least one of intonation, elevation, or intensity from the utterance of the speaker; and
learning to obtain at least one region-specific weight information corresponding to the obtained at least one utterance feature data.

8. The method of claim 1, further comprising processing the utterance of the speaker as natural language based on the updated word embedding information.

9. The method of claim 1, further comprising obtaining optimal word embedding Information by learning to obtain at least one or more region-specific weight information for each word included in the utterance of the speaker each time the speaker speaks.

10. The method of claim 9, wherein the word embedding information updated each time the speaker speaks is close to the optimal word embedding information.

11. A speech processing device comprising:
a memory configured to store word embedding information; and
a processor,
wherein the processor
learns to obtain at least one region-specific weight information for each word included in an utterance of a speaker, and
updates the word embedding information based on the at least one region-specific weight information obtained for each of the word.

12. The speech processing device of claim 11, wherein the processor learns to obtain the word embedding information corresponding to word data before learning to obtain the weight information.

13. The speech processing device of claim 12, wherein the word embedding information is updated for a word used for obtaining the at least one region-specific weight information.

14. The speech processing device of claim 11, wherein the word data comprises at least one dialect for each word, and
the at least one dialect comprises a standard language.

15. The speech processing device of claim 11, wherein word embedding information comprises a vector value indicating a similar relationship between at least one dialect and a plurality of dimensions.

16. The speech processing device of claim 15, wherein the processor calculates each of the at least one region-specific weight and each of the vector values to update the word embedding information.

17. The speech processing device of claim 11, wherein the processor
obtains at least one utterance feature data comprising at least one of intonation, elevation, or intensity from the utterance of the speaker; and
learns to obtain at least one region-specific weight information corresponding to the obtained at least one utterance feature data.

18. The speech processing device of claim 11, wherein the processor processes the utterance of the speaker as natural language based on the updated word embedding information.

19. The speech processing device of claim 11, wherein the processor obtains optimal word embedding Information by learning to obtain at least one or more region-specific weight information for each word included in the utterance of the speaker each time the speaker speaks.

20. The speech processing device of claim 19, wherein the word embedding information updated each time the speaker speaks is close to the optimal word embedding information.
